(19) United States
(12) Patent Application Publication
(10) Pub. No.: US 2026/0202530 A1
(43) Pub. Date: Jul. 16, 2026

(54) DISTANCE DETERMINATION TO PHYSICAL OBJECT

(71) Applicant: Telefonaktiebolaget LM Ericsson (publ), Stockholm (SE)

(72) Inventors: Henrik SJÖLAND, LUND (SE); Stefan ADALBJÖRNSSON, Austin, TX (US); Oscar NOVO DIAZ, Jorvas (FI)

(21) Appl. No.: 19/137,370

(22) PCT Filed: Dec. 19, 2022
(86) PCT No.: PCT/EP2022/086777

§ 371 Date: Jun. 10, 2025

(51) Int. Cl. G01S 11/14; G06F 3/01; H04R 1/02; H04R 1/40; H04R 3/00

(52) U.S. Cl. CPC G01S 11/14; G06F 3/011; H04R 1/028; H04R 1/406; H04R 3/005

(57) ABSTRACT

Embodiments presented herein relate to a wearable device (100) for echolocation arranged to be worn by a user. The wearable device includes a processing circuitry adapted to acquire, from at least one microphone operatively connected to the wearable device, a sound signal (S) of the user's footsteps or clapping. The processing circuitry is adapted to acquire, from at least one sensor operatively connected to the wearable device, a sensor reading (T) indicative of the user's footsteps or clapping. Thereafter, a direct sound signal (SDI) that corresponds in time with the sensor reading (T), and a reflected sound signal (SRE) of the user's footsteps or clapping, are identified. Based on the direct sound signal (SD)} and the reflected sound signal (SRE), both originating from the sound signal(S), a distance to at least one physical object (O) in the vicinity of the user is determined.

### TECHNICAL FIELD

Embodiments presented herein relate to a device, method, computer program, computer program product and an apparatus for determining a distance to at least one physical object in the vicinity of a user.

### BACKGROUND

There has always been a need for awareness of surroundings, both in well-lit, low-light or pitch-black environments. For example, awareness of surroundings is vital for pedestrians, or workers in sewers, mines, and other dark environments, or in cloudy places such as mountains and skyscrapers.

One example of technology used for awareness of surroundings is thermographic cameras, or thermal cameras, which are mainly employed in rainy, or foggy environments. Such cameras measure thermal radiation to generate images from their field of view. Consequently, the generated images are far less affected by rain, snow, fog, smog, or anything in the environment that can block light. Moreover, thermal cameras can pick up movements with high accuracy—a technical feature that is largely used in security systems. Combined with Video Content Analysis (VCA) technology, thermal cameras can offer a wide range of real-life solutions, such as line-crossing detection.

Other examples of technology used for low-light and pitch-black monitoring are InfraRed (IR) sensor illuminators, image intensifiers, and low-light lenses.

Various depth sensors have also been explored in the automotive industry for accurate and reliable location and mapping. Radio detection and ranging (RADAR) and light detection and ranging (LIDAR) are prominent examples and provide excellent results for depths from a few meters up to a few hundred meters. By combining depth sensors with inertial measurement unit (IMU) sensors or other sensors that estimate a vehicle's motion, a map can be attained that shows the vehicle moving around. Similarly, for Augmented reality glasses, visual features are identified and tracked over time and in combination with IMU sensors or similar sensors.

Thermal and LIDAR sensors, though, can be quite expensive. In addition, RADAR can sometimes require a lot of computation, i.e., processing power, to process the data. Hence, there is a need for improved, cost-effective, and reliable devices and methods for determining a distance to at least one physical object in the vicinity of a user.

### SUMMARY

Embodiments presented herein relate to a device, method, computer program, computer program product and an apparatus for determining a distance to at least one physical object in the vicinity of a user. It should be appreciated that these embodiments can be implemented in numerous ways. Several of these embodiments are described below.

According to a first aspect there is presented a wearable device arranged to be worn by a user, the wearable device designed for determining a distance to at least one physical object in the vicinity of the user. Furthermore, the wearable device comprises a processing circuitry adapted to acquire, from at least one microphone operatively connected to the wearable device, a sound signal of the user's footsteps or clapping. Moreover, the processing circuitry is adapted to acquire, from at least one sensor operatively connected to the wearable device, a sensor reading indicative of the user's footsteps or clapping. Moreover, the processing circuitry is adapted to identify a direct sound signal of the user's footsteps or clapping, the direct sound signal being comprised in the acquired sound signal, as a sound signal that corresponds in time with the sensor reading indicative of the user's footsteps or clapping. Moreover, the processing circuitry is adapted to identify a reflected sound signal of the user's footsteps or clapping, the reflected sound signal being comprised in the acquired sound signal. Moreover, based on the direct sound signal and the reflected sound signal, a distance to at least one physical object in the vicinity of the user is determined.

According to a second aspect there is presented a method for determining a distance to at least one physical object in vicinity of a user wearing a wearable device. The method comprises acquiring, from at least one microphone operatively connected to the wearable device, a sound signal of the user's footsteps or clapping. Moreover, the method comprises acquiring, from at least one sensor operatively connected to the wearable device, a sensor reading indicative of the user's footsteps or clapping. Moreover, a direct sound signal of the user's footsteps or clapping is identified, the direct sound signal being comprised in the acquired sound signal, as a sound signal that corresponds in time with the sensor reading indicative of the user's footsteps or clapping. Moreover, a reflected sound signal of the user's footsteps or clapping is identified, the reflected sound signal being comprised in the acquired sound signal. Moreover, based on the direct sound signal and the reflected sound signal, a distance to at least one physical object in the vicinity of the user is determined.

According to a third aspect there is presented an apparatus configured to perform the method according to the second aspect.

According to a fourth aspect there is presented a computer program comprising instructions, which when executed by processing circuitry, carries out the method according to the second aspect.

According to a fifth aspect there is presented a computer program product comprising a non-transitory storage medium including program code to be executed by a processing circuitry of a wearable device, whereby execution of the program code causes the wearable device to perform operations comprising acquiring, from at least one microphone operatively connected to the wearable device, a sound signal of the user's footsteps or clapping as well as acquiring, from at least one sensor operatively connected to the wearable device, a sensor reading indicative of the user's footsteps or clapping. Moreover, the operations comprising identifying a direct sound signal of the user's footsteps or clapping, the direct sound signal being comprised in the acquired sound signal, as a sound signal that corresponds in time with the sensor reading indicative of the user's footsteps or clapping, as well as identifying a reflected sound signal of the user's footsteps or clapping, the reflected sound signal being comprised in the acquired sound signal. Moreover, the operations comprising determining, based on the direct sound signal and the reflected sound signal, a distance to at least one physical object in the vicinity of the user.

Advantageously, these aspects provide embodiments to determine a distance to at least one physical object in the vicinity of a user without generating any additional audible sounds other than sounds created by the user. Thus, power consumption and battery weight for the wearable device can be reduced.

Other objectives, features and advantages of the enclosed embodiments will be apparent from the following detailed description, from the attached dependent claims as well as from the drawings.

### BRIEF DESCRIPTION OF THE DRAWINGS

FIG. 1 is showing a user who is wearing a wearable device for determining a distance to at least one physical object in the vicinity of the user.

FIG. 2 is showing two schematically illustrated graphs, the top one being a sound envelope for the direct sound signal and the reflected sound signal, and the bottom one being a signal from the at least one sensor of a user's footstep or a user's clap that corresponds in time with the direct sound signal, according to an embodiment of the disclosure.

FIG. 3 is showing functional units of the wearable device, according to embodiments.

FIG. 4 is showing functional units of the method for determining a distance to at least one physical object in vicinity of a user wearing a wearable device, according to an embodiment of the disclosure.

FIG. 5 is showing a computer program product and a computer program, according to an embodiment of the disclosure.

FIG. 6 is showing the principle of selecting an information-carrying part of the user's step or user's clap.

### DETAILED DESCRIPTION

The disadvantages with current technology for detecting and locating physical objects are, for example:
Thermal and LIDAR sensors are quite expensive.
RADAR requires a lot of computation, i.e., processing power, to process the measurements.
Visual only and Visual-Inertial simultaneous location and mapping (SLAM) also require quite a lot of computation for the processing of visual data.
A visual-based SLAM system may fail in various situations related to the vision sensor, for example due to low light, fog, smoke, or a lack of identifiable visual features.

The aim of embodiments presented herein is to help a user determine a distance to a physical object O in the vicinity of the user based on the principles of echolocation.

Echolocation, also called bio sonar, is a biological sonar used for navigation, foraging, and hunting by several animal species, e.g., bats and dolphins. Echolocating animals emit calls out to the environment and listen to the echoes of those calls that return from various nearby physical objects, thus making it possible for the echolocating animals to locate and identify those nearby physical objects.

Some people, mainly blind and visually impaired persons, have attained the ability to detect and locate physical objects in their environment by sensing echoes from those objects, by actively creating sound pulses, e.g., rhythmic vibrations or regular pulsations of air, by stomping their foot, or making clicking noises with their mouths. This skill is called human echolocation.

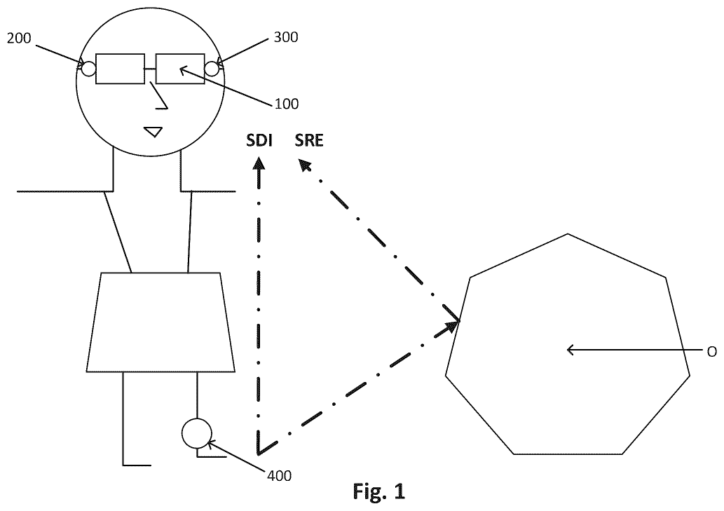

FIG. 1 illustrates a user who is wearing a wearable device 100 for determining a distance to at least one physical object O in the vicinity of the user, in accordance with embodiments of the invention. The wearable device 100 comprises a processing circuitry PC, which is adapted to acquire a sound signal S of the user's footsteps or clapping. The sound signal S is acquired from at least one microphone 200, which is operatively connected to the wearable device 100. The processing circuitry PC is further adapted to acquire a sensor reading T, which is indicative of the user's footsteps or clapping. The sensor reading T is acquired from at least one sensor 400 which is operatively connected to the wearable device 100. The processing circuitry PC is further adapted to identify a direct sound signal SDI of the user's footsteps or clapping. The direct sound signal SDI is comprised in the acquired sound signal S and is identified as a sound signal that corresponds in time with the sensor reading T indicative of the user's footsteps or clapping. The processing circuitry PC is further adapted to identify a reflected sound signal SRE of the user's footsteps or clapping. The processing circuitry PC is further adapted to determine a distance to at least one physical object O in the vicinity of the user. The distance is determined based on the direct sound signal SDI and the reflected sound signal SRE.

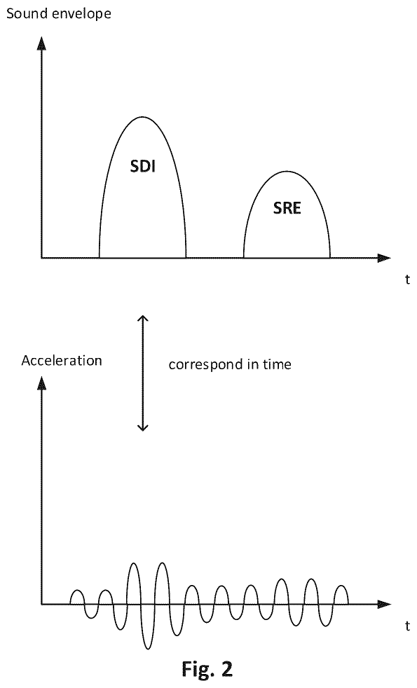

FIG. 2. illustrates the sound envelope (the upper graph) and the acceleration (the lower graph). The y-axis of the upper graph is showing the sound envelope of the direct sound signal SDI and the sound envelope of the reflected sound signal SRE. The x-axis of the upper graph is showing the time t. The y-axis of the lower graph is showing the acceleration of a footstep sound or a clapping sound. The x-axis of the lower graph is showing the time t. The upper and the lower graphs correspond in time, and consequently, the point in time when the acceleration of the footstep sound or the clapping sound has a peak in the lower graph is the same point in time when the sound envelope of the direct sound signal SDI has a peak in the upper graph. In addition, the point in time when the second-highest acceleration peak can be found in the lower graph corresponds with the point in time when the sound envelope of the reflected sound signal SRE has a peak in the upper graph.

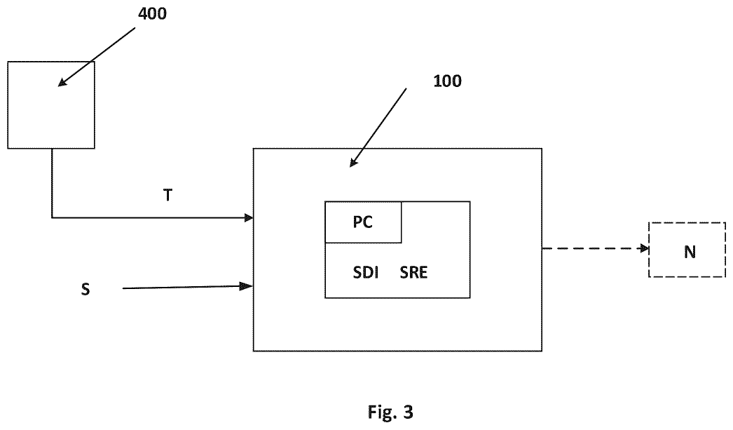

FIG. 3 is showing functional units of the wearable device 100, including processing circuitry PC that may further be adapted to generate a notification N to the user. The notification N is generated under the condition that the distance to the at least one physical object O is below a threshold distance. The generated notification N may, e.g., comprise at least one of a displayed image, a haptic signal, and an audible sound.

The wearable device 100 may comprise one of a helmet, a hat, augmented reality glasses, and virtual reality glasses.

The user may be a pedestrian, a person (i.e., a human being), a robot or an animal, e.g., a monkey or a dog.

A footstep sound is the generated sound of each step that a user takes when walking or running. A footstep typically generates broadband frequency vibrations in the ground or floor, as well as sound in the air, from a few Hertz up to ultrasonic frequencies, depending on footwear and material the user is walking on, due to striking and sliding contacts between a foot and the ground or floor. The embodiments described herein mainly concern a footstep sound that typically falls within the frequency range of 1 Hz to 1500 Hz and even more typically within the range of 10 to 1000 Hz, the latter of which corresponds to a wavelength range of 34.3 to 0.343 meters.

Clapping is defined as striking two things, for example the palms of the user's hands, together repeatedly. The sound caused by flat human hand clapping, i.e., when the hand clapping is made with flat human hands, typically falls within the frequency range of 1 to 10 kHz, corresponding to a wavelength range of 0.343 to 0.0343 meters. When the hand clapping is made with cupped human hands, the sound caused by cupped human hand clapping typically falls within the frequency range of 0.1 to 2 kHz, which corresponds to a wavelength range of 3.43 to 0.17 meters.

A physical object O can be a stone, a tree, a vehicle, a surface, a wall, a closed door, a lamppost, a person, a robot, an animal, or any other kind of physical object or obstacle that may pose a collision risk for the user wearing the wearable device 100.

The vicinity of the user is defined as the area in front of the user (or the area in every direction around the user) within the range of 0-10 meters, preferably within the range of 0-5 meters and even more preferably within the range of 0-2 meters.

A notification N is generated 170 to the user under the condition that the distance to the at least one physical object O is below a threshold distance. The threshold distance can be manually set by the user or be a preset value within the range of 0-10 meters, preferably a preset value within the range of 0-5 meters and even more preferably a preset value within the range of 0-2 meters.

The notification N generated to the user can comprise at least one of a displayed image, a haptic signal, and an audible sound. The displayed image can be shown to the user in the wearable device 100, if the wearable device 100 is augmented reality glasses or virtual reality glasses, both of which comprise a screen or display. Haptic signals can typically be vibrations, e.g., in a mobile phone or smartphone, or a rumble (i.e., a continuous, low-frequency sound), or focused ultrasound beams used to create a localized sense of pressure, e.g., on the user's finger without touching any physical object.

The distance to the at least one physical object O in the vicinity of the user is determined based on a time delay between the direct sound signal SDI and the reflected sound signal SRE. More specifically, the distance to the at least one physical object O in the vicinity of the user is determined based on the time delay between the direct sound signal SDI and the reflected sound signal SRE not exceeding a threshold time, and/or an amplitude ratio between the direct sound signal SDI and the reflected sound signal SRE not exceeding a threshold amplitude. The threshold time can be manually set by the user or be a preset value within the range of 0-54 ms, preferably a preset value within the range of 0-25 ms and even more preferably a preset value within the range of 0-10 ms. The threshold amplitude can be set to 50 or preferably set to 30, meaning that the amplitude ratio, i.e., the ratio between the amplitude of the direct sound signal SDI and the amplitude of the reflected sound signal SRE shall not exceed 50, or preferably not exceed 30 (the latter corresponding to a power ratio of about 1000).

The at least one sensor 400 may be an accelerometer and/or a gyroscope. In an embodiment, the accelerometer and/or the gyroscope is/are comprised in a footwear worn by the user and is arranged to acquire the sensor reading T indicative of the user's footsteps. Else, in another embodiment, the accelerometer and/or the gyroscope is/are comprised in a smartwatch or wristband, for example attached to a wrist of the user, and is arranged to acquire the sensor reading T indicative of the user's clapping. In another embodiment, the at least one sensor 400 is at least one camera and is/are arranged to acquire image data of the user's footsteps or clapping. In an embodiment, the microphone 200 is a microphone array 200, 300. In an embodiment, the wearable device 100 is further adapted to perform beamforming for determining the direction to the at least one physical object O. In yet another embodiment, a user-specific transfer function is determined, or a generic transfer function is used, for determining the direction to the at least one physical object O.

At least one camera is used in one embodiment to acquire image data of the user's footsteps or clapping. The camera could also be used for detecting the user's footsteps by not capturing the user's feet, but instead capturing the background of the bouncing image of the user's footsteps when the user is walking or running.

An accelerometer is a sensor that measures physical acceleration (i.e., measurable acceleration as by an accelerometer) experienced by a physical object. Thus, it is acceleration relative to a free-fall, or inertial, observer who is momentarily at rest relative to the physical object being measured.

A gyroscope is a device used for measuring orientation and angular velocity.

Footwear is defined as outer coverings for the feet, e.g., the user's feet, the outer coverings being, e.g., shoes, boots, sandals, or socks.

A smartwatch is a wearable computer in the form of a watch. A wristband is a strip of material usually worn around the wrist, e.g., the user's wrist. The wristband can be made by, e.g., gold, silver, leather, or an absorbent material.

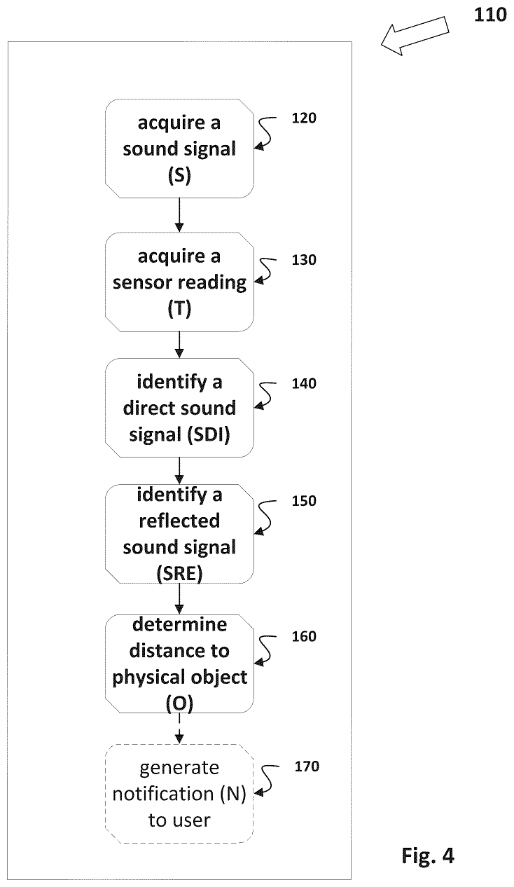

In the following text, embodiments of the method 110 for determining a distance to at least one physical object O in vicinity of a user wearing a wearable device 100 are described with reference to FIG. 4. The method 110 comprises acquiring 120, from at least one microphone 200 operatively connected to the wearable device 100, a sound signal S of the user's footsteps or clapping. Moreover, the method 110 comprises acquiring 130, from at least one sensor 400 operatively connected to the wearable device 100, a sensor reading T indicative of the user's footsteps or clapping. A direct sound signal SDI of the user's footsteps or clapping is identified 140, the direct sound signal SDI being comprised in the acquired sound signal S, as a sound signal that corresponds in time with the sensor reading T indicative of the user's footsteps or clapping. Moreover, a reflected sound signal SRE of the user's footsteps or clapping is identified 150. A distance to at least one physical object O in the vicinity of the user is determined 160 based on the direct sound signal SDI and the reflected sound signal SRE.

In an embodiment, the method 110 is performed by a processing circuitry PC in the wearable device 100. The wearable device 100 may comprise one of a helmet, a hat, augmented reality glasses, and virtual reality glasses. In an embodiment, the method 110 further comprises generating 170 a notification N to the user under the condition that the distance to at least one physical object O is below a determined threshold distance. In yet another embodiment, the notification N generated 170 to the user comprises at least one of a displayed image, a haptic signal, and an audible sound.

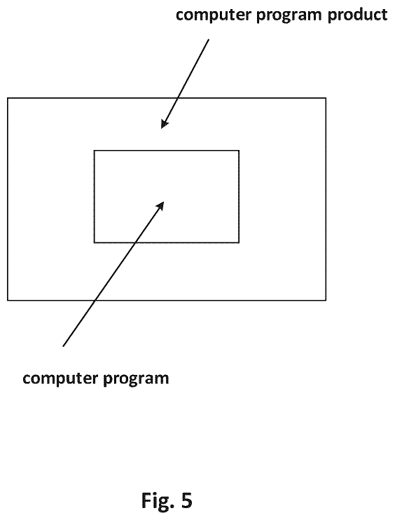

FIG. 5 illustrates a computer program C comprising instructions, which when executed by processing circuitry PC, carries out the method 110 according to the second aspect.

FIG. 5 also illustrates a computer program product comprising a non-transitory storage medium including program code to be executed by a processing circuitry PC of a wearable device 100, whereby execution of the program code causes the wearable device 100 to perform operations comprising acquiring, from at least one microphone 200 operatively connected to the wearable device 100, a sound signal S of the user's footsteps or clapping as well as acquiring, from at least one sensor 400 operatively connected to the wearable device 100, a sensor reading T indicative of the user's footsteps or clapping. Thereafter, the operations comprising identifying a direct sound signal SDI of the user's footsteps or clapping, the direct sound signal SDI being comprised in the acquired sound signal S, as a sound signal that corresponds in time with the sensor reading T indicative of the user's footsteps or clapping, as well as identifying a reflected sound signal SRE of the user's footsteps or clapping. Moreover, the operations comprising determining, based on the direct sound signal SDI and the reflected sound signal SRE, a distance to at least one physical object O in the vicinity of the user. In an embodiment, the wearable device 100 comprises one of a helmet, a hat, augmented reality glasses, and virtual reality glasses. In another embodiment, a notification N is generated to the user under the condition that the distance to at least one physical object O is below a threshold distance. In yet another embodiment, the at least one microphone 200 is a microphone array 200, 300.

A detailed description of calculations made in the embodiments follows below.

### Calculation of Distance to a Physical Object

The sound of the user's footsteps or clapping, represented below as the function ƒ_{footstep}(k), where k is the k:th sample, propagates in different paths that can be received by the at least one microphone (200) operatively connected to a wearable device (100). The sound of the user's footsteps or clapping will first arrive in the direct path after τ_{direct} seconds, represented below as the function ƒ_{direct}(k), also known as a direct sound signal (SDI), see FIG. 1.

$${f}_{direct} ( k ) = {f}_{footstep} ( k - {τ}_{direct} )$$

If a physical object (O) is present in the vicinity of the user, a reflected sound signal (i.e., an echo or SRE) will arrive after τ_{reflected} seconds, represented below as the function ƒ_{reflected}(k). Then, depending on the distance to the physical object (O), the sound signal of the reflected path (i.e., an echo or SRE) will arrive:

$${f}_{reflected} ( k ) = {f}_{footstep} ( k - {τ}_{reflected} )$$

A sound signal (S) received at the at least one microphone (200), represented below as the function ƒ_{received}(k), will thus be the superposition of the footstep or clapping sound of the user delayed by τ_{reflected} and τ_{direct}:

$${f}_{received} ( k ) = {f}_{reflected} ( k ) + {f}_{direct} ( k ) + noise$$

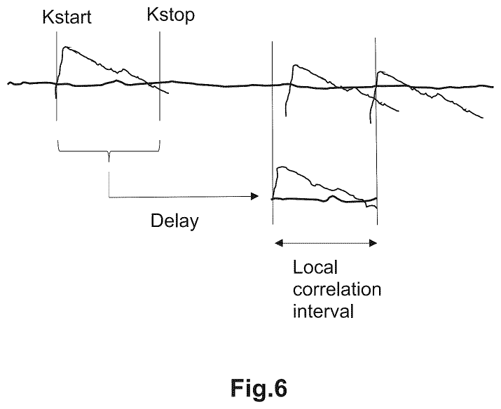

In general, autocorrelation is defined as the correlation of a signal with a delayed copy of itself as a function of delay. The analysis of autocorrelation is a mathematical tool for finding repeating patterns, such as the presence of a periodic signal obscured by noise, or identifying the missing fundamental frequency in a signal implied by its harmonic frequencies. It is often used in signal processing for analyzing functions or series of values, such as time domain signals. By correlating the sound signal(S) with itself delayed by different units of time (e.g., seconds or minutes), presence of various physical objects at different distances from the user can be detected. In this case, in order to reduce noise, correlation calculations are carried out by limiting the correlation interval to the points in time when the user's footstep or user's clap starts and stops, i.e., between Kₛₜₐᵣₜ and Kₛₜₒₚ, see FIG. 6, and by looking for peaks in the autocorrelation function:

$${R}_{XX} ( l ) = {\sum }_{k = Kstart}^{Kstop} f ( k ) * {f}_{received} ( k - {K}_{start} + l )$$

where ƒ(k) is ƒ_{received}(k) for k in [Kₛₜₐᵣₜ, Kₛₜₒₚ] and zero otherwise. Kₛₜₐᵣₜ will be set by estimating, based on a sensor reading (T) indicative of the user's footsteps or clapping, when the user's foot touches the ground or the user's one hand touches the user's other hand in a clap (i.e., the direct sound signal (SDI)), see further section “How to filter the noise: time domain filtering” below. Kₛₜₒₚ will be set as explained in the section “Kₛₜₒₚ estimation” below. An index I will be calculated for l in [0, Lₘₐₓ] where Lₘₐₓ is the maximum detectable distance, 10 meters, which corresponds to 55 ms that, in turn, corresponds to 2640 samples if the sample rate is 48 kSample/s. A peak at l indicates the presence of a reflection or, in other words, that the received reflected sound signal (i.e., an echo or SRE) is like a time-shifted version of itself.

The distance from the user's foot (or the user's hand) to the wearable device (100) (worn by the user) could, as an alternative, be estimated based on first estimating τ_{direct}, and thereafter, the distance traveled could be corrected by assuming that the distance traveled corresponds to an isosceles triangle, i.e., a triangle with two equal sides and two equal angles, where the one deviating side is the distance from the ground to the wearable device (100). As another alternative, prior knowledge of the height of the user who is wearing the wearable device (100) can be used to make a distance estimate between the user's foot and the wearable device (100) worn by the user. These two alternatives are suitable for detecting a physical object (O) that is located at a close distance to the user wearing a wearable device (100), for example between 1 to 3 meters.

### How to Filter the Noise: Time-Domain Filtering

Apart from the user's own footsteps or clapping, i.e., the sound source in these embodiments, also other sounds are being reflected in the environment, and the beamforming capabilities (see the “Beamforming” section below) at audible frequencies (i.e., between 20 Hz and 20 kHz) will be limited due to the wavelength. Consequently, separating the sound coming from the user's feet or hands by beamforming will not be sufficient. Thus, time-domain filtering should also be applied, using at least one sensor (400, e.g., an accelerometer) to detect the point in time of the user's footstep or user's clap in order to find the associated direct sound of the user's footstep or user's clap (i.e., the direct sound signal (SDI)), see FIG. 2. As described previously, by analyzing the data from the sensor reading T (e.g., from at least one accelerometer), the point in time when the user's foot touches the ground (i.e., the direct sound signal (SDI)) can be found, thus identifying Kstart as defined above in section “Calculation of distance to a physical object”.

The time delay between the direct sound of the user's step or user's clap and the registered direct sound (as determined by the sensor reading T) of the user's step or user's clap by the at least one microphone (200) will be approximately the same for each of the user's steps or user's claps. This circumstance, i.e., a determined time delay, can be used in order to simplify the sensor-based time-domain filtering described above for filtering out the direct sound of the user's step or user's clap from the acquired sound signal (S) by the at least one microphone (200).

### Kₛₜₒₚ Estimation

As described above, in order to minimize the impact of noise, Kₛₜₐᵣₜ and Kₛₜₒₚ can be set to limit the autocorrelation to sound samples where the user's footstep or clapping sound provides significant contribution to the correlation. Correlations made over a larger interval will add noise but no significant, useful information about detected physical objects. As can be seen in FIG. 6, the information-carrying part of the user's footstep or user's clap is selected, then delayed, and then correlated with the received reflected sound signal (i.e., an echo or SRE). Each correlation is only performed over the information-carrying part in order to minimize the impact of noise.

The length of the information-carrying part of the signal will depend on the walking style of the user and on ground/floor conditions. Some adaptivity is therefore needed for best performance. Thus, in order to select the Kₛₜₐᵣₜ and Kₛₜₒₚ values, different Kₛₜₐᵣₜ and Kₛₜₒₚ values may be investigated in parallel, with different relations to the sensor data detecting the direct sound of the user's step or user's clap (i.e., the direct sound signal (SDI)). Thereafter, the strength of the correlation peaks for different Kₛₜₐᵣₜ and Kₛₜₒₚ values can be compared, and settings that provide the highest signal-to-noise ratio (SNR) can be found. By comparing the correlation peak energy to the length of the correlation interval, where noise is assumed to be proportional to the correlation length, an estimate of the SNR can be obtained and maximized. Furthermore, the combination of Kₛₜₐᵣₜ and Kₛₜₒₚ is used to give the highest estimated SNR. For the processing of the next received reflected sound signal (i.e., an echo or SRE), the initial Kₛₜₐᵣₜ and Kₛₜₒₚ values are numerically closer to the next Kₛₜₐᵣₜ and Kₛₜₒₚ values.

### Beamforming

The reflected sound signal (i.e., an echo or SRE) received by the microphones (200,300) may be subject to beamforming and be correlated with the time-delayed sound pulses of the user's footsteps or clapping that, in turn, have been identified by beamforming and time domain filtering.

Beamforming or spatial filtering is a signal processing technique whereby radio or sound signals can be steered in a specific direction, undesirable interference sources can be eliminated and/or the signal-to-noise ratio (SNR) of received signals can be improved. Beamforming is widely used in, e.g., radars and sonar systems, biomedical, and particularly in communications (telecom, Wi-Fi), specially 5G.

In general terms, beamforming can be used in sensor arrays for directional signal transmission or reception. This is achieved by combining elements in an antenna array in such a way that signals at particular angles experience constructive interference while others experience destructive interference. Beamforming can be used at both the transmitting and receiving ends in order to achieve spatial selectivity. The improvement compared with omnidirectional reception/transmission is known as the directivity of the array.

By performing beamforming, i.e., carry out the signal processing technique of beamforming, the direction of the physical object (O) can be determined in current embodiments. In order to perform beamforming for determining the direction of the physical object (O), a microphone array (200,300) is needed. Commonly, the signal of the user's footstep or user's clap is more than one meter from the at least two microphones or a microphone array (200,300), and thus the simplifying far-field approximation can be used. In order to explain this further, it should be noted that the sound propagates at about 343 m/s, resulting in a wavelength of 17 m at 20 Hz and 17 mm at 20 kHz, representing the general limits of the audible sound range. For a representative frequency of 1 kHz the wavelength is 34 cm. Placing microphones much closer than half this wavelength, i.e., 17 cm, will only benefit the highest frequencies. Therefore, in order to determine the direction of audible sound, it is typically sufficient to use one microphone on each of the two opposite sides of the user's head, i.e., at least two microphones or a microphone array comprising at least two microphones (200,300). In order to determine the distance to a physical object (O), however, one microphone (200) is usually sufficient.

Delay and sum (DAS) beamforming is one of the most common and robust beamforming algorithms. A DAS beamformer applies a delay and an amplitude weight to the output of each included sensor, and then sums the resulting signals. The delays are chosen to maximize the array's sensitivity to incoming sound pulses from a particular direction. By adjusting the delays, the array's look-direction can be steered towards the sound source, and the waveforms captured by the individual sensors add constructively. Thus, signals at particular angles experience constructive interference, while others experience destructive interference.

Embodiments enclosed herein concern bistatic measurements, i.e., measurements carried out when the sound source and the microphone/s are at different locations. Thus, there is some interdependence between distance and direction that may be investigated. Distance estimate accuracy will benefit from information about angle of arrival, especially for nearby physical objects. The beamforming can be performed at first, and thereafter, correlation for echoes can be made for each direction separately, i.e., for each considered angle, θₖ:

$${R}_{XX} ( l {θ}_{k} ) = {\sum }_{k = Kstart}^{Kstop} {f}^{′} {θ}_{k} ( k ) * f {θ}_{k} ( k - {K}_{start} + l {θ}_{k} )$$

where ƒθₓ is the output of the beamformer for angle θₖ and ƒ′θₖ(k) is zero outside [Kₛₜₐᵣₜ, Kₛₜₒₚ]. Then, the desired estimated delay and angle of arrival is determined as lθₖ for which R_{XX}(lθₖ) is maximized.

### Head-Related Transfer Functions

A head-related transfer function (HRTF) is a response that characterizes how an ear receives a sound from a point in space. As a sound wave propagates towards a listener's ears, the size and shape of the head, ears, ear canal, density of the head, size and shape of nasal and oral cavities, all transform the sound and affect how it is perceived, boosting some frequencies and attenuating others. Generally speaking, the HRTF boosts frequencies from 2-5 kHz with a primary resonance of +17 dB at 2,700 Hz. However, the response curve is more complex than a single peak, affects a broad frequency spectrum, and varies significantly from person to person.

A pair of head-related transfer functions (HRTFs) for two ears can be used to synthesize a binaural sound that seems to come from a particular point in space. It is a transfer function, describing how a sound from a specific point will arrive at the ear (generally at the outer end of the auditory canal). Some consumer home entertainment products designed to reproduce surround sound from stereo (two-speaker) headphones use HRTFs. Some forms of HRTF-processing have also been included in computer software to simulate surround sound playback from loudspeakers.

The HRTF can also be described as the modifications to a sound from a direction in free air to the sound as it arrives at the eardrum. These modifications include the shape of the listener's outer ear, the shape of the listener's head and body, the acoustic characteristics of the space in which the sound is played, and so on. All these characteristics will influence how (or whether) a listener can accurately tell what direction a sound is coming from.

In the current embodiments, HRTFs can be introduced, leading to improved detection of the vertical direction of a sound, i.e., information on whether a sound is coming from above or below. In addition, consideration is taken to the attenuation and phase shift at different frequencies when signals propagate to the microphones or microphone array (200,300), which typically are placed on opposite sides of the user's head. In this case, the propagation to the eardrum is not used, but instead to the microphone array (200,300) outside the user's head. Weights of the signals from the microphones, i.e., weights in both amplitude and phase, are then adjusted by the inverse of the HRTFs for the particular beam direction when beamforming is performed. The HRTF may be calibrated for each individual user (i.e., a user-specific transfer function). More commonly, however, an approximative head model (i.e., a generic transfer function) may be sufficient and thus used instead.

ABBREVIATIONS

| Abbreviation | Explanation |
|---|---|
| AR | Augmented Reality |
| HRTF | Head-Related Transfer Function |
| IMU | Inertial Measurement Unit |
| IR | Infrared |
| LIDAR | Light Detection and Ranging |
| RADAR | Radio Detection and Ranging |
| VR | Virtual Reality |

1. A wearable device arranged to be worn by a user, the wearable device designed for determining a distance to at least one physical object (O) in the vicinity of the user, the wearable device comprising a processing circuitry (PC) adapted to:
acquire, from at least one microphone operatively connected to the wearable device, a sound signal (S) of the user's footsteps or clapping;
acquire, from at least one sensor operatively connected to the wearable device, a sensor reading (T) indicative of the user's footsteps or clapping;
identify a direct sound signal (SDI) of the user's footsteps or clapping, the direct sound signal (SDI) being comprised in the acquired sound signal(S), as a sound signal that corresponds in time with the sensor reading (T) indicative of the user's footsteps or clapping;
identify a reflected sound signal (SRE) of the user's footsteps or clapping, the reflected sound signal (SRE) being comprised in the acquired sound signal(S); and
determine, based on the direct sound signal (SDI) and the reflected sound signal (SRE), a distance to at least one physical object (O) in the vicinity of the user.

2. The wearable device according to claim 1, wherein the wearable device comprises one of a helmet, a hat, augmented reality glasses, and virtual reality glasses.

3. The wearable device according to claim 1, wherein a notification (N) is generated to the user under the condition that the distance to the at least one physical object (O) is below a threshold distance.

4. The wearable device according to claim 1, wherein the distance to the at least one physical object (O) in the vicinity of the user is determined based on at least one of:
a time delay between the direct sound signal (SDI) and the reflected sound signal (SRE) not exceeding a threshold time; and
an amplitude ratio between the direct sound signal (SDI) and the reflected sound signal (SRE) not exceeding a threshold amplitude.

5. The wearable device according to claim 3, wherein the notification (N) generated to the user comprises at least one of a displayed image, a haptic signal, and an audible sound.

6. The wearable device according to claim 1, wherein the at least one sensor is at least one accelerometer and/or at least one gyroscope.

7. The wearable device according to claim 6, wherein the at least one accelerometer and/or the at least one gyroscope is/are comprised in a footwear worn by the user and is/are arranged to acquire the sensor reading (T) indicative of the user's footsteps.

8. The wearable device according to claim 6, wherein the at least one accelerometer and/or the at least one gyroscope is/are comprised in a smartwatch or wristband and is arranged to acquire the sensor reading (T) indicative of the user's clapping.

9. The wearable device according to claim 1, wherein the at least one sensor is at least one camera and is arranged to acquire image data of the user's footsteps or clapping.

10. The wearable device according to claim 1, wherein the at least one microphone is a microphone array.

11. The wearable device according to claim 10, wherein the wearable device is further adapted to perform beamforming for determining the direction of the at least one physical object (O).

12. The wearable device according to claim 1, further comprising determining a user-specific transfer function or using a generic transfer function for determining the direction of the at least one physical object (O).

13. A method for determining a distance to at least one physical object (O) in vicinity of a user wearing a wearable device, the method comprising:
acquiring, from at least one microphone operatively connected to the wearable device, a sound signal (S) of the user's footsteps or clapping;
acquiring, from at least one sensor operatively connected to the wearable device, a sensor reading (T) indicative of the user's footsteps or clapping;
identifying a direct sound signal (SDI) of the user's footsteps or clapping, the direct sound signal (SDI) being comprised in the acquired sound signal(S), as a sound signal that corresponds in time with the sensor reading (T) indicative of the user's footsteps or clapping;
identifying a reflected sound signal (SRE) of the user's footsteps or clapping, the reflected sound signal (SRE) being comprised in the acquired sound signal(S); and
determining, based on the direct sound signal (SDI) and the reflected sound signal (SRE), the distance to the at least one physical object (O) in the vicinity of the user.

14. The method according to claim 13, wherein the method is performed by a processing circuitry (PC) of the wearable device.

15. The method according to claim 13, wherein the wearable device comprises one of a helmet, a hat, augmented reality glasses, and virtual reality glasses.

16. The method according to claim 13, further comprising generating a notification (N) to the user under the condition that the distance to the at least one physical object (O) is below a threshold distance.

17. The method according to claim 13, wherein the distance to the at least one physical object (O) in the vicinity of the user is determined based on at least one of:
a time delay between the direct sound signal (SDI) and the reflected sound signal (SRE) not exceeding a threshold time; and
an amplitude ratio between the direct sound signal (SDI) and the reflected sound signal (SRE) not exceeding a threshold amplitude.

18. The method according to claim 16, wherein the notification (N) generated to the user comprises at least one of a displayed image, a haptic signal, and an audible sound.

19. The method according to claim 13, wherein the at least one sensor is at least one accelerometer and/or at least one gyroscope.

20. The method according to claim 19, wherein the at least one accelerometer and/or the at least one gyroscope is/are comprised in a footwear worn by the user and is/are arranged to acquire the sensor reading (T) indicative of the user's footsteps.

21-31. (canceled)
